(19) United States
(12) Patent Application Publication
(10) Pub. No.: US 2012/0288217 A1
(43) Pub. Date: Nov. 15, 2012

(54) HIGH DYNAMIC RANGE (HDR) IMAGE SYNTHESIS WITH USER INPUT

(76) Inventors: Jiefu Zhai, Cupertino, CA (US); Zhe Wang, Plainsboro, NJ (US); Dong-Qing Zhang, Plainsboro, NJ (US)

(21) Appl. No.: 13/574,919

(22) PCT Filed: Jan. 25, 2011
(86) PCT No.: PCT/US11/00133

§ 371 Date: Jul. 24, 2012

(30) Foreign Application Priority Data
Jan. 27, 2010 (US) 61336786

(51) Int. Cl. G06T 5/50

(52) U.S. Cl. 382/294

(57) ABSTRACT

A new high dynamic range image synthesis which can handle the local object motion, wherein an interactive graphical user interface is provided for the end user, through which one can specify the source image for separate part of the final high dynamic range image, either by creating a image mask or scribble on the image. The high dynamic range image synthesis includes the following steps: capturing low dynamic range images with different exposures; registering the low dynamic range images; estimating camera response function; converting the low dynamic range images to temporary radiance images using estimated camera response function; and fusing the temporary radiance images into a single high dynamic range (HDR) image by employing a method of layered masking.

### CROSS-REFERENCE TO RELATED APPLICATIONS

This application is claims benefit of the filing date under 35 U.S.C. §119(e) of Provisional Patent Application No. 61/336,786, filed Jan. 27, 2010.

### FIELD OF INVENTION

The present invention relates to a method of generating a high dynamic range (HDR) image, and in particular, a method of generating a high dynamic range (HDR) image from multiple exposed low dynamic range (LDR) images having local motion.

### BACKGROUND OF THE INVENTION

Dynamic range of the real world is very large, usually more than five orders of magnitude at the same time. The dynamic range of everyday scenes can hardly be recorded by a conventional sensor. Therefore some portions of the picture can be over-exposed or under-exposed.

In recent years, High Dynamic Range (HDR) imaging techniques make it possible to reconstruct the radiance map that covers the full dynamic range by combining multiple exposures of the same scene. These techniques usually estimate the camera response function (CRF), and then further estimate the radiance of each pixel. This is generally known as “HDR synthesis”.

However, a large number of high dynamic range (HDR) synthesis algorithms assume that there is no local object motion between the multiple exposures of the same scene (see P. E. Debevec and J. Malik, Recovering high dynamic range radiance maps from photographs, ACM Siggraph 1998; A. A. Bell, C. Seiler, J. N. Kaftan and T. Aach, Noise in High Dynamic Range Imaging, International conference on image processing 2008; and N. Barakat, T. E. Darcie, and A. N. Hone, The tradeoff between SNR and exposure-set size in HDR imaging, International conference on image processing 2008).

In some cases local object motion is absent, especially in landscape photograph; however, it is not always true in a great number of circumstances. In fact, ghosting artifacts will appear in a final synthesized high dynamic range (HDR) image if local motion is present in the exposures of the same scene. Therefore, most recent research focus on automatically removing local object motion, as disclosed in E. A. Khan, A. O. Akyuz, and E. Reinhard, Ghost removal in high dynamic range images, International conference on image processing 2006; K. Jacobs, C. Loscos and G. Ward, Automatic high dynamic range image generation for dynamic scenes, IEEE Computer Graphics and Applications, 2008, and T. Jinno and M. Okuda, Motion blur free HDR image acquisition using multiple exposures, International conference on image processing 2008.

It is believed that available methods have two main issues: at first, some methods rely on local motion estimation to isolate moving objects. However, motion estimation is not always reliable especially in case of large displacement. Inaccurate motion will sometimes cause artifacts that are visually unpleasant (see Jinno et al.). Secondly, there is usually less than enough exposures to remove moving object by statistical filtering or similar techniques. Some previously proposed method may work well in case that many exposures are taken for the same scene such that the static background can be estimated with statistical model (see Khan et al.). In practice, it is difficult to define how many exposures are enough to eliminate the uncertainty and in many circumstances it is impossible to have enough exposures.

Debevec et al. proposed an early method to combine multiple exposures into a high dynamic range (HDR) image. In their method, it is assumed that the camera is placed on a tripod and there is no moving object. The method starts with the estimating of camera response function using least square optimization. Afterwards, the CRF is used to convert pixel value into relative radiance value. The final absolute radiance is obtained by multiplying a scaling constant.

In Bell et al. and Barakat et al., the noise issue in high dynamic range (HDR) image is discussed and improved image synthesis methods are proposed. However, the results are essentially the same as the one obtained from Debevec et al., except with higher SNR. Note that in these works it is also assumed that there is no camera motion and no moving object.

In Khan et al., Jacobs et al, and Jinno et al. on the other hand, the problem of local motion was faced and there were attempts to eliminate ghosting artifacts. In Khan et al., no explicit motion estimation is employed. Instead, the weight to compute the pixel radiance is estimated iteratively and applied to pixels to determine their contribution to the final image. This approach usually need enough exposure to eliminate ghosting artifacts and can still have minor ghosting if picture is examined carefully. In Jinno et al., pixel-level motion estimation is employed to calculate the displacement between different exposures while at the same time, the occlusion and saturated areas are also detected. Then a Markov random field model is used to fuse the information to obtain final high dynamic range (HDR) image. As we pointed out before, this method relies on accurate motion estimation and can exhibits artifacts wherever motion estimation fails. In Jacobs et al., the moving object detection is done by computing the entropy difference between different exposures. For each moving cluster only one exposure is used to recover the radiance of the moving object instead of using a weighted average of radiance values. This method can be generally good in handling object movement, but can still have a problem with complex object motion. Artifacts will be exhibited in the area where the motion detector fails as can be observed in the figures of the paper.

### SUMMARY OF THE INVENTION

The invention provides a new semi-automatic high dynamic range (HDR) image synthesis method which can handle the local object motion, wherein an interactive graphical user interface is provided for the end user, through which one can specify the source image for separate part of the final high dynamic range (HDR) image, either by creating a image mask or scribble on the image. This interactive process can effectively incorporate the user's feedback into the high dynamic range (HDR) image synthesis and maximize the image quality of the final high dynamic range (HDR) image.

A method of high dynamic range (HDR) image synthesis with user input includes the steps of: capturing low dynamic range images with different exposures; registering the low dynamic range images; obtaining or estimating camera response function; converting the low dynamic range images to temporary radiance images using estimated camera response function; and fusing the temporary radiance images into a single high dynamic range (HDR) image by employing a method of layered masking.

In another method of high dynamic range (HDR) image synthesis, a user performs the steps of: capturing low dynamic range images with different exposures; registering the low dynamic range images; estimating camera response function; converting the low dynamic range images to temporary radiance images by using the estimated camera response function; and fusing the temporary radiance images into a single high dynamic range (HDR) image by obtaining a labeling image L, wherein the value of a pixel in the labeling image represents its temporary radiance image at that particular pixel.

### BRIEF DESCRIPTION OF THE DRAWINGS

The invention will now be described by way of example with reference to the accompanying figures of which:

FIG. 1 is a flow chart showing steps of a high dynamic range (HDR) synthesis according to the invention, and addresses localized motion between multiple low dynamic range (LDR) images;

FIG. 2A is a collection of source low dynamic range (LDR) images having localized motion;

FIG. 2B is a tone mapped synthesized high dynamic range (HDR) image having a ghosting artifact displayed in a graphical user interface box;

FIG. 3 is a flow chart of a high dynamic range (HDR) image synthesis according to the invention having user controlled layered masking; and

FIG. 4 is a flow chart of another high dynamic range (HDR) image synthesis according to the invention that solves labeling problems.

### DETAILED DESCRIPTION OF THE INVENTION

The invention will now be described in greater detail with reference to the figures.

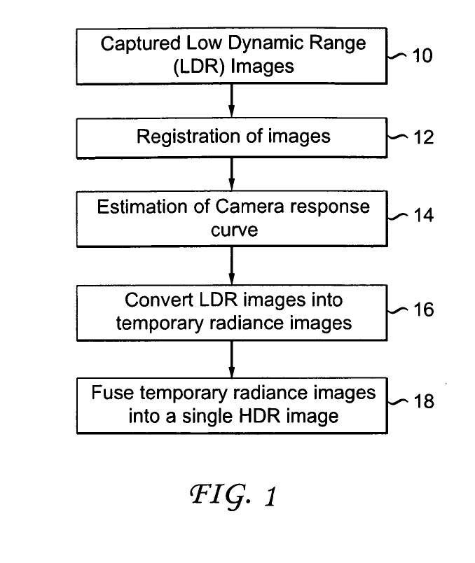

With respect to FIG. 1, the general steps of a high dynamic range (HDR) synthesis according to the invention are described. The first step of a high dynamic range (HDR) synthesis, according to the invention, is to capture several low dynamic range (LDR) images with different exposures at step 10. This is usually done by varying the shutter speed of a camera such that each LDR image captures a specific range of a high dynamic range (HDR) scene. In subsequent step 12, all images are registered, such to eliminate the effect of global motion. In general, the image registration process transforms the LDR images into a one coordinate system in order to compare or integrate the LDR images. This can be done with a Binary Transform Map, for example.

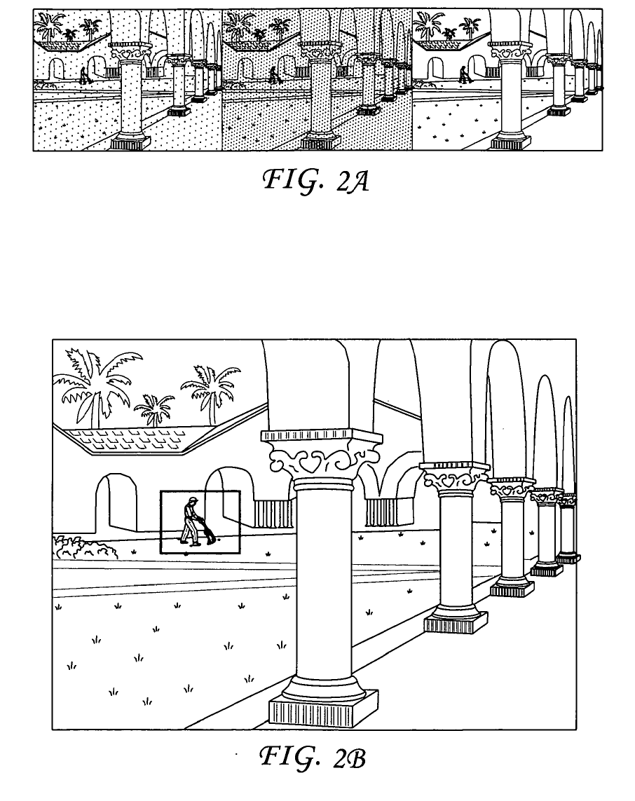

When there is local motion between selected LDR images, registration between LDR images can still be done effectively, as well as the camera response curve estimation. However, the fusion process is sometimes problematic because of the uncertainty of local motion. Ghosting artifacts can be observed if the fusion method fails. FIG. 2B illustrates ghosting artifacts in a high dynamic range (HDR) image from a collection of LDR images (see FIG. 2A) and synthesized by commercial software (i.e. photomatix, for example). However, if maximum quality of the high dynamic range (HDR) image is required, such artifacts are undesirable and should be eliminated completely. To achieve this goal, user input is introduced to resolve uncertainty and imperfections during the fusion process. According to the invention, one of the low dynamic range (LDR) images is chosen as a reference image to perform registration and all the other low dynamic range (LDR) images are registered to align with this reference image. The reference image is carefully chosen by the area, e.g., the area with local motion should be under an optimal exposure value in the low dynamic range (LDR) image chosen as the reference image.

After the low dynamic range (LDR) images are registered, the camera response function (CRF) can be estimated at step 14, and consequently all low dynamic range (LDR) images are then converted to temporary radiance images by using the estimated camera response function (CRF) at step 16. A temporary radiance image represents the physical quantity of light at each pixel. It is similar to a high dynamic range (HDR) image, except that the values of some pixels are not reliable due to the saturation in highlight. In subsequent steps, a fusion process 20 is used to combine the information in these temporary radiance images into a final high dynamic range (HDR) output.

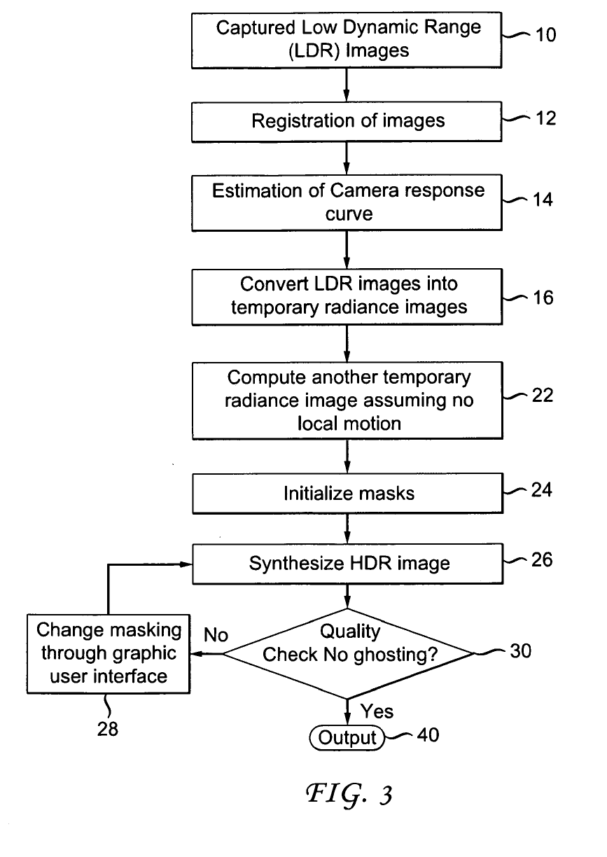

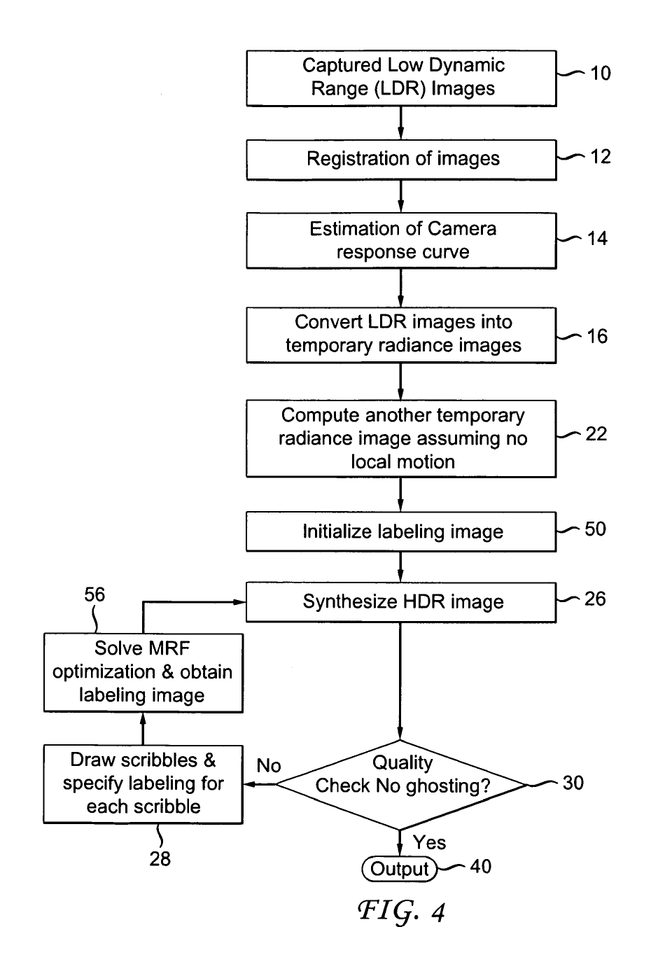

The high dynamic range (HDR) synthesis according to the invention focuses on steps during the fusion process. With reference to FIGS. 3 and 4, the high dynamic range (HDR) synthesis, according to the invention, provides two methods of differing complexity and flexibility.

The first method, subsequent steps of the fusion process 20, is based on layered masking and has a straightforward control of the fusion process 20. The first method has low complexity and is easy to implement steps, but may need more user input than a second method, other subsequent steps of the fusion process 20. The second method tries to solve labeling problems within a Markov random field framework, which requires less user control than the first method.

With reference to FIG. 3, the high dynamic range (HDR) synthesis is shown having subsequent steps of the fusion process 20, which are based on layered masking.

At step 22, the temporary radiance images are treated as layers and a mask is created for each layer. Assume the temporary radiance images and their corresponding aligned LDR images (intensity) are represented by Rⁱ and Iⁱ (i=1 . . . N), and another temporary radiance image is created by a weighted average of Rⁱ. For a pixel with coordinate (x, y), the value of the pixel is expressed as:

R_{x,y}^{N+1}=Σᵢ₌₁^{N}W(I_{x,y}ⁱ)I_{x,y}ⁱ, (1)

where W(I) is a weighting function and could take the form:

$$W ( x ) = \{ \begin{matrix}0 , & x < 3 or x > 253 \\ 1 , & else .\end{matrix} \qquad ( 2 )$$

Here, x in W(x) in (2) is the value of I and N or n is the number of layers.

Essentially, the new temporary radiance image Rⁿ⁺¹ is an initial high dynamic range (HDR) image that is synthesized at step 26, which is consistent with known. However, as pointed out earlier, this high dynamic range (HDR) image assumes there is no local motion in the low dynamic range (LDR) images. Then a set of binary masks Mⁱ are created for these temporary radiance images (step 24) and the initial value of Mⁱ are set as follows:

M_{x,y}^{N+1}=1 for all x, y, and (3)

M_{x-y}ⁱ=0 for all x, y and i≠N+1. (4)

It is important to note that the use binary masks can be used and can turn out to be quite sufficient. In general, these masks can be floating point and meet the following requirement:

0≦M_{x,y}ⁱ≦1 for all x,y and i., and (5)

Σᵢ₌₁^{N+1}M_{x,y}ⁱ=1 for all x,y. (6)

The high dynamic range (HDR) image is synthesized at step 26, as

Σᵢ₌₁^{N+1}M_{x,y}ⁱ=1 for all x, y. (7)

Now the user is given the flexibility to change the mask with a graphics user interface at step 28. For instance, in FIG. 2B, the only ghost happens within the rectangle and this particular area has only limited dynamic range. Thus the user can choose to mask out the specific area only from one proper exposed input image. More specifically, this can be described for all coordinates (x,y) within red rectangle, set as:

M_{x,y}^{K}=1 and (8)

M_{x,y}ⁱ=0 for i≠N+1. (9)

where K is the index of input image which does not have over-exposure or under-exposure in the specific area (within rectangle in this example).

Once the user changes the masks, Eq. (7) is used again to regenerate the synthesized high dynamic range (HDR) image and, then a tone map is employed. The synthesized high dynamic range (HDR) image is presented to the user for further modification of masking, or if a quality check is performed at step 30, and no apparent ghosting is present, then an output of the final high dynamic range (HDR) image is provided at step 40.

The second method will be discussed with reference to FIG. 4. While the previous method is flexible and the user has very good control of eliminating ghosting, the first method, however, may require more manual effort than the second method in some cases. Therefore, a further method, the second method, is proposed that transforms the mask generation problem into a labeling problem, and then uses an optimization method such as Markov Random Field (MRF) to solve the labeling problem.

In the first method, although the masks can be binary or floating point number, it has been discovered that binary masks are sufficient. In such a case, the value of each pixel in the final high dynamic range (HDR) image is only from one temporary radiance image. In another term, one can consider the fusion process as a labeling problem, where each pixel is given a label that is representative of its source image. To get the final high dynamic range (HDR) image, a user copies the radiance value from its source image for each pixel.

In the second method, after step 22 as described above, labeling of the image is performed at step 50. Formally, labeling image L, whose value can be from 1 to N+1, is sought. The value of a pixel in the label image represents its source temporary radiance image at that particular pixel. At the very beginning, the label image L can be initialized to have labeling (N+1) for every pixel. The high dynamic range (HDR) image is synthesized in the same way as step 26. If a ghosting artifact is present at step 30, then a graphic user interface is used by the user to scribble on the areas that contain ghosting artifacts and specify the labeling for these scribbles at step 54. Different from the previous first method, where user has to carefully create the mask to cover all pixels that has a ghosting artifact(s), the user draws a few simple scribbles, and does not need to necessarily cover all the pixels that are affected by the ghosting artifact(s). The user's scribbles define the labeling for the underlying pixels; therefore the next step is to infer the labeling for the rest pixels in the labeling image L.

To achieve this goal, one can employ the Markov Random Field (MRF) framework to solve this inference problem, at step 56. In MRF framework, the labeling problem can be transformed into an optimization problem as follows. The labeling image should minimize the following cost function:

J(L)=ΣD(L_{x,y})+λΣV(L_{x,y},L_{x′,y′}) (10)

The cost function contains two terms, where the first term is usually called data fidelity term and the second term smoothness term.

The data terms define the “cost” if a pixel is labeled as a particular value. In this problem, one defines the data term in following way:

If a pixel (x,y) is on a user-defined scribble and specified as label i then

$$D ( {L}_{x , y} ) = \{ \begin{matrix}0 , & {L}_{x , y} = i \\ ∞ , & else\end{matrix} \qquad ( 11 )$$

If a pixel (x,y) is not on a user-defined scribble, then L_{x,y}=j and

$$D ( {L}_{x , y} ) = \{ \begin{matrix}∞ , & {I}_{x , y}^{{L}_{x , y}} = 255 or {I}_{x , y}^{{L}_{x , y}} = 0 \\ 1 , & else\end{matrix} \qquad ( 12 )$$

For the smoothness term, one can define it as below, although more complicated smoothness function can also be used:

$$V ( i , j ) = \{ \begin{matrix}0 , & i = j \\ abs ( i - j ) , & i \neq j\end{matrix} \qquad ( 13 )$$

Once the cost function is well defined, an algorithm, such as Graph-cut or Belief-Propagation, can be used to solve the optimization problem efficiently. The flow of this method is shown in FIG. 4. Once the user performs the labeling, Eq. (7) is used again to regenerate the synthesized high dynamic range (HDR) image and, then a tone map is employed. The synthesized high dynamic range (HDR) image is presented to the user for further modification by labeling, or if a quality check is performed at step 30, and no apparent ghosting is present, then an output of the final high dynamic range (HDR) image is provided at step 40.

While certain embodiments of the present invention have been described above, these descriptions are given for purposes of illustration and explanation. Variations, changes, modifications and departures from the systems and methods disclosed above may be adopted without departure from the scope or spirit of the present invention.

1. A method of high dynamic range image synthesis comprising the steps of:
capturing low dynamic range images with different exposures;
registering the low dynamic range images;
using a camera response function to convert the registered low dynamic range images to temporary radiance images; and
fusing the temporary radiance images into a single high dynamic range (HDR) image by layered masking.

2. The method of claim 1, wherein the registration of the low dynamic range images is done by a binary transformation map.

3. The method of claim 1, wherein one of the low dynamic range images is chosen as a reference image to perform registration and the other low dynamic range images are registered to align with the reference image.

4. The method of claim 3, wherein the chosen reference image has an area with local motion with an optimal exposure value.

5. The method of claim 1, further comprising the step of treating the temporary radiance images as layers.

6. The method of claim 5, further comprising the step of creating a mask for each layer.

7. The method of claim 1, further comprising the step of creating another temporary radiance image by a weighted average of the temporary radiance images.

8. The method of claim 7, wherein a pixel of the other temporary radiance image created by the weighted average is expressed by the equation R_{x,y}^{N+1}=Σᵢ₌₁^{N}W(I_{x,y}ⁱ)(I_{x,y}ⁱ), where N is the number of layers, x,y represents a pixel coordinate and I corresponds to the intensity of low dynamic range images of the layers.

9. The method of claim 8, wherein the weighting average is expressed by the function
$$W ( x ) = \{ \begin{matrix}0 , & x < 3 or x > 253 \\ 1 , & else\end{matrix} ,$$
where x in W(x) corresponds to the intensity of the given low dynamic range images of the layers.

10. The method of claim 7, further comprising the step of creating a set of binary masks Mⁱ for the temporary radiance images.

11. The method of claim 10, wherein initial values of the set of binary masks are set to M_{x,y}^{N+1}=1 for all x,y and M_{x,y}ⁱ=0 for all x,y and i≠N+1, where N is the number of layers and x,y represent pixel coordinates.

12. The method of claim 10, further comprising the step of synthesizing a high dynamic range image.

13. The method of claim 12, further comprising the step of choosing a particular area having local motion to mask out local motion from one exposure.

14. The method of claim 13, further comprising the step of applying a tone mapping to the synthesized high dynamic range image.

15. The method of claim 14, wherein the tone mapping is a process to convert radiance values of the pixels in a radiance image to an intensity value of the pixels.

16. The method of claim 13, further comprising a step of regenerating a final synthesized high dynamic range image for an output of a modified high dynamic range image.

17. A method of high dynamic range synthesis comprising the steps of
capturing low dynamic range images with different exposures;
registering the low dynamic range images;
obtaining or estimating camera response function;
converting the low dynamic range images to temporary radiance images by using the estimated camera response function; and
fusing the temporary radiance images into a single high dynamic range image by obtaining a labeling image L wherein a value of a pixel in the labeling image represents its temporary radiance image at that particular pixel.

18. The method of claim 17, further comprising the step of scribbling over pixels that are affected by local motion in the labeling image L.

19. The method of claim 18, wherein scribbles define labeling for underlying pixels in the labeling image L.

20. The method of claim 18, further comprising the step of inferring labeling for the rest pixels in the labeling image L.

21. The method of claim 20, further comprising the step of employing a Markov Random Field framework.

22. The method of claim 20, further comprising the step of minimizing a cost function.

23. The method of claim 22, wherein the cost function is expressed by the formula
$$D ( {L}_{x , y} ) = \{ \begin{matrix}∞ , & {I}_{x , y}^{{L}_{x , y}} = 255 or {I}_{x , y}^{{L}_{x , y}} = 0 \\ 1 , & else\end{matrix} ,$$
where I corresponds to the intensity of low dynamic range images of the layers.

24. The method of claim 23, wherein if a pixel (x,y) is on a user-defined scribble and specified as label i then
$$D ( {L}_{x , y} ) = \{ \begin{matrix}0 , & {L}_{x , y} = i \\ ∞ , & else\end{matrix} .$$

25. The method of claim 24, wherein if a pixel (x,y) is not on a user-defined scribble, then L_{x,y}=j and
$$D ( {L}_{x , y} ) = \{ \begin{matrix}∞ , & {I}_{x , y}^{{L}_{x , y}} = 255 or {I}_{x , y}^{{L}_{x , y}} = 0 \\ 1 , & else\end{matrix} .$$

26. The method of claim 25, wherein a smoothness function of the cost function is expressed by the formula
$$V ( i , j ) = \{ \begin{matrix}0 , & i = j \\ abs ( i - j ) , & i \neq j\end{matrix} .$$

27. The method of claim 22, further comprising a step of generating a synthesized high dynamic range image for an output of a final high dynamic range image.
